(19) United States
(12) Patent Application Publication
(10) Pub. No.: US 2013/0275353 A1
(43) Pub. Date: Oct. 17, 2013

(54) SYSTEMS AND METHODS FOR SELECTING MEDIA ITEMS

(71) Applicants: Michael I. Ingrassia, JR., Cupertino, CA (US); Richard M. Powell, Cupertino, CA (US); Jeffery T. Lee, Cupertino, CA (US)

(72) Inventors: Michael I. Ingrassia, JR., Cupertino, CA (US); Richard M. Powell, Cupertino, CA (US); Jeffery T. Lee, Cupertino, CA (US)

(73) Assignee: APPLE INC., Cupertino, CA (US)

(21) Appl. No.: 13/448,288

(22) Filed: Apr. 16, 2012

(51) Int. Cl. G06N 5/02

(52) U.S. Cl. 706/46

(57) ABSTRACT

Systems and methods are provided for selecting media items for playing on a user media device and generating a playlist of media items based on factors such as the operating state of the user media device, a predicted change in the operating state of the media player device associated with playing or retrieving the media item, and the desirability of the media item to the user.

### FIELD

This application relates to selecting media items, and, more particularly, to generating a personalized playlist of media items.

### BACKGROUND

Media players are no longer limited to allowing a user to play individual songs and manually create playlists, but can also generate playlists automatically. The automatically generated playlists arrange songs in the user's media library with the goal of providing a pleasant experience that mimics a personalized radio station.

Furthermore, a media player may have access to a large number of sources of media content. For example, a user may maintain the majority of their media library on a desktop computer, and download only a subset to their cellular phone. Both the desktop and the cellular phone may be capable of connecting to the Internet in order to download further media content, or to stream it directly from the Internet.

Media players are frequently implemented on mobile devices such as laptops, cellular phones and MP3 players. However, these devices present developers with more severe design constraints than traditional stationary media devices such as desktop computers. Users expect the same features and media quality as on stationary devices, while also having a lightweight mobile device with a long battery life. Accordingly, there is a need to take into account at least these two conflicting factors in order to provide the most enjoyable overall user experience.

### SUMMARY

The application, in various implementations, provides systems, methods and devices for selecting media items for playing on a user media device and generating a playlist of media items based on factors such as the operating state of the user media device, a predicted change in the operating state of the media player device associated with playing or retrieving the media item, and the desirability of the media item to the user.

In certain configurations, the monitored operating state includes the remaining battery life of the user media device, the temperature of the user media device, the load of a processor of the user media device, or the remaining space in a memory component of the user media device. The operating state may be monitored only when a playlist is generated or also continuously while the playlist is playing.

In certain configurations, predicting the change in the operating state associated with a media item involves calculating the change based on attributes associated with the media, involves a previously generated look-up table, or is based on a measured change in operating state due to a previous media item. The predicted change in the operating state can also take into account potential future changes in the operating state.

In certain configurations, the desirability of a media item is based on the desirability of a previous or a future media item. In some configurations, the user media device retrieves media items from multiple sources. These may include a remote server and an internal storage component. The media device may also have access to multiple versions of the same media content, but in different formats.

In certain configurations, media items are evaluated on an individual basis. Multiple media items may also be compared with each other based on rankings or calculated scores. Multiple media items may also be added to the playlist simultaneously.

In another aspect, a media device includes a monitor unit, function, and/or application arranged to monitor its operating state. The media device also includes a media player unit that is arranged to: identify media items of the media content available for playing on the user media device. The media player unit predicts a change in the operating state associated with acquiring and/or playing one or more of the media items. The media player unit evaluates a desirability of the one or more media items to the user. If the one or more media items meet a playlist criteria, based at least in part on the evaluated desirability to the user, the operating state of the user media device, and the predicted change in the operating state of the user media device, the media player unit adds the one or more media items to the playlist. If the one or more media items does not meet the playlist criteria, based at least in part on the evaluated desirability to the user, the operating state of the user media device, and the predicted change in the operating state of the user media device, the media player unit does not add the one or more media items to the playlist.

In certain configurations media items are purchased from a media store. In this configuration financial considerations can be an additional factor considered when generating a playlist or can be incorporated into existing factors, such as the desirability of a media item to the user. These financial considerations may include the user's budget, the cost of the media item to the user, the cost of the media item to the provider, and any profit the provider may make by having the user purchase the media item.

Various advantages and applications for using a playlist generation system and interface in accordance with principles of the present disclosure are discussed in more detail below.

### BRIEF DESCRIPTION OF THE DRAWINGS

The above and other features of the present application, its nature and various advantages will become more apparent upon consideration of the following detailed description, taken in conjunction with the accompanying drawings, in which like reference characters refer to like parts throughout, and in which:

FIG. 1 is a diagram of an operating environment of a media device;

FIG. 2 is a diagram of the internal components of an exemplary media device;

FIGS. 3A and 3B are diagrams of user interfaces for providing playlists on the media device;

FIG. 4 is a diagram of a playlist containing media items from multiple sources;

FIG. 5 is a diagram of a playlist that includes media items in one or more video formats;

FIG. 6 is a table comparing media items that can be added to the playlist;

FIG. 7 is a table comparing the media items of FIG. 6 at a later point in time;

FIG. 8 is a table comparing media items based on financial considerations;

FIG. 9 is a flow diagram of a first version of a process for generating a playlist;

FIG. 10 is a flow diagram of a second version of a process for generating a playlist;

FIG. 11 is a flow diagram of a third version of a process for generating a playlist;

FIG. 12 is flow diagram of a first version of a process for selecting media items to be added to a playlist.

FIG. 13 is flow diagram of a second version of a process for selecting media items to be added to a playlist;

FIG. 14 is flow diagram of a third version of a process for selecting media items to be added to a playlist.

### DETAILED DESCRIPTION OF THE DISCLOSURE

The application, in various implementations, provides systems, methods and devices for selecting media items for playing on a user media device and generating a playlist of media items based on factors such as the operating state of the user media device, a predicted change in the operating state of the media player device associated with playing or retrieving the media item, and the desirability of the media item to the user.

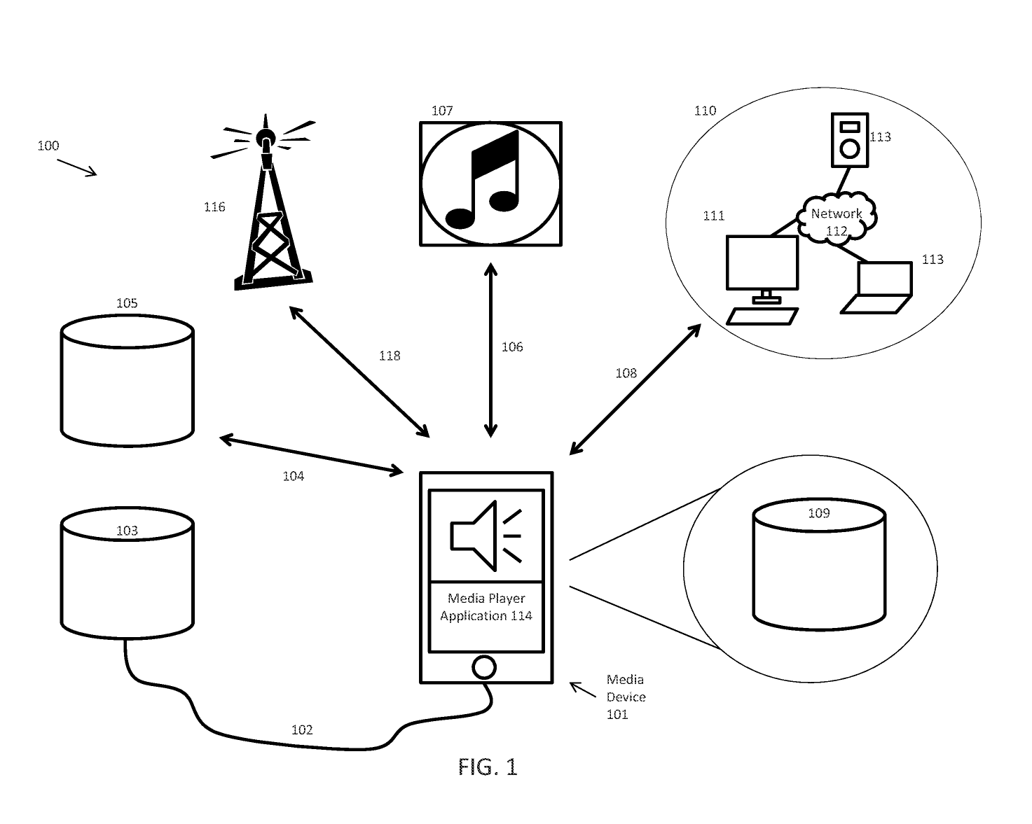

FIG. 1 is a diagram of the operating environment 100 of a media device 101. The operating environment 100 of media device 101 includes internal storage 109, external storage 103 via connection cable 102, external storage 105 via connection 104, home network 110 via connection 108, media store 107 via connection 106, radio station 116 over connection 118, and media player application 114. The home network 110 may include a computer 111 and/or other devices 113.

While this application may refer to mobile user devices, such as the cellular phone shown in FIG. 1, the systems and methods described in this application can be applied to stationary devices, such as desktop computers and servers. For example, because temperature is becoming a larger concern for servers, a media player application 114 may take temperature into account when generating playlists for a media server according to the methods described in this application.

The media device 101 may include a media player application, unit, and/or function 114. By default, media player application 114 may allow the user to play media items stored on internal storage 109. While most discussion in this application will focus on songs as the media items, the methods described herein are in no way limited to songs. Media items may also include videos, images, text, and/or any other type of digital files a user may want to access. The meaning of the term “to play” may depend on the format of the media item. If the media item is a song, playing may involve having speakers of media device 101 generate the audio of the song. In the case of videos, playing includes both an audio component and displaying video on a display of the user media device 101.

Media content refers to the content of a media item. A user may store two copies of the same song; one on their media device 101 and the other at a remote server. While these two copies are two media items, each contains the same media content. Two versions of the same media content, that are stored as separate files and potentially in different formats, may be considered two media items.

Internal storage 109 may store a large collection of media items; however, additional media items may be stored on other user media devices. The combination of all media owned and/or stored by the user that can be accessed from a media device 101 is referred to as the user's music library or media library. In one implementation, a collection of all media items accessible by the user media device 101 is referred to as a media library.

Media device 101 can be connected to any number of other devices over one or more connections, in which case a user's media library includes media items stored on all those devices. In FIG. 1, for example, media device 101 is connected to external storage 103 via USB connection cable 102 and connected to external storage device 105 via a wireless connection 104. Media device 101 may also be able to access the user's Home Network 110 via wireless connection 108. Wireless connections may include WiFi, BLUETOOTH, mobile, and/or other wireless protocols. This is advantageous where a user downloads only a subset of their media library to their media device 101, and keeps the majority of their media items on, for example, desktop computer 111. Media device 101 may have direct access to all the devices of home network 110, or may access a gateway device, such as desktop computer 111, which can then retrieve media items from other devices, such as devices 113, to which the desktop computer is connected via network 112.

Media device 101 may also be directly connected to the Internet or other remote servers over wireless data connection 106. Wireless data connection 106 can be a 3G or 4G cellular wireless standard. This allows media device 101 to retrieve media items found on other remote servers, stream media items from the Internet and even purchase new media content from media store 107 through a service such as iTUNES®.

Media device 101 may also have access to radio source 116 over connection 118. This may be a regular terrestrial radio, in which case connection 118 may be AM or FM radio, or radio station 116 may be an Internet radio station, which case connection 118 can be another wireless connection. Media content currently playing on radio station 116 may also be considered a media item, and may be considered part of the media library. Media device 101 may determine what media content is playing on radio station 116 using information received along with the media content over connection 118, or based on information obtained from any other connection. For example, if radio station 116 is a terrestrial radio station, media device 101 may access a website of the radio station to retrieve information regarding the media content currently being broadcast by radio station 116.

The user media device may have access to any other device over any type of connection.

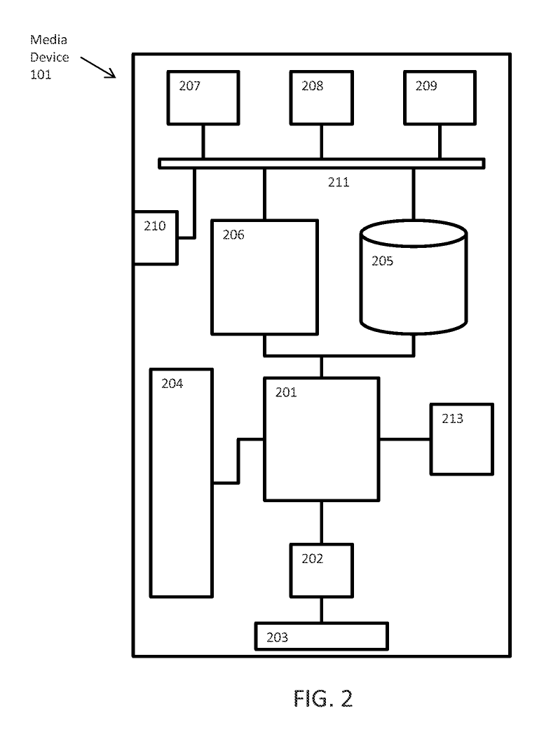

FIG. 2 is a functional diagram of the media device 101. Media device 101 includes WiFi modem 207, 3G wireless modem 208, BLUETOOTH modem 209, bus 211, USB port 210, RAM memory 206, data storage 205, battery 204, processor 201, temperature sensor 213, DSP 202 and speakers 203. WiFi modem 207, 3G wireless modem 208 and BLUETOOTH modem 209 may be separate components or combined into a single component.

In operation, USB port 210 and/or modems 207, 208 and/or 209 may enable access to media items on devices external to media device 101. USB port 210 and/or modems 207, 208 and/or 209 may use share bus 211 to access RAM memory 206 and data storage 205. Data storage 205 may include a hard drive, solid state memory, CD-ROM, CD-RW, memory card, and/or any non-volatile memory device. Media player application 114 may include a software application that runs on processor 201. When a user provides input to media player application 114 to play a specific media item, such as a song stored on data storage 205, processor 201 can direct DSP 202 to play the song over speakers 203.

If a media item selected by the user is located on an external device, processor 201 may download the desired media item to data storage 205 via one or more of USB port 207 and modems 208, 209, and 210. Alternatively, instead of downloading the full media item and storing it to data storage 205, processor 201 may direct one or more of connections 207-210 to begin downloading the media item to RAM memory 206. From there, DSP 202 can begin processing and playing the media item as it is being downloaded, with no copy of the media item being permanently stored by media device 101. This process is commonly known as streaming.

Processor 201 may monitor the amount of battery charge remaining in battery 204 of the media device 101 and/or monitor the temperature of media device 101 using temperature sensor 213. Processor 201 may be able to call low-level drivers to retrieve this information or read a hardware register of these components directly. In one configuration, the processor 201 may include a monitor unit, application, and/or function arranged to monitor an operating state of a user media device such as device 101.

The charge remaining in battery 204 and the temperature of media device 101 are two examples of the “operating state” of media device 101. The operating state may include the state of a component of media device 101 that may affect the overall performance of media device 101, but may be independent of any individual software process. One aspect of the operating state may include the remaining charge of battery 204. Other aspects of the operating state may include the temperature of media device 101 or any of its components, the amount of memory space remaining in data storage 205 or RAM memory 206, the bandwidth available on bus 211, and the current processing load of processor 201 or any other computing component. Other aspects of the operating state may be monitored and, therefore, the methods and systems described in this application are not limited to the examples described above. In certain configuration, the quality of a wireless connection does not qualify as an aspect of the operating state of media device 101, because it is not a state of a component of the media device 101.

As will be discussed in more detail below, processor 201 may also be able to predict what effect individual media items may have on any operating state of media device 101. For example, processor 201 may predict how an operating state will change due to retrieving or playing a song. As will be described in further detail below, processor 201 may also evaluate the desirability of media items to the user. Aside from playing media items selected by the user, media player application 114 may also automatically generate playlists for the user.

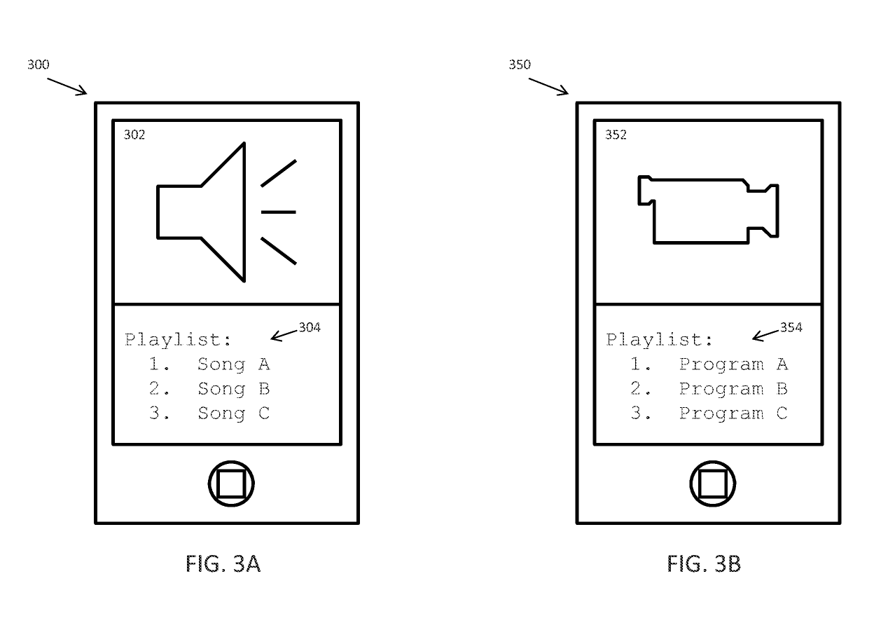

FIGS. 3A and 3B are diagrams of user interfaces 300 and 350 respectively for providing playlists 302 and 352 on the media device 101.

Playlist 302 of FIG. 3A is a playlist of songs. Media player application 114 automatically selects the set 304 of songs to be played and the order in which they will be played. They are then sequentially played. While playlist 302 already contains a number of songs, the next songs may also be chosen only when the previous song is about to end. In particular, and as will be discussed further below, media player application 114 may select a set 304 of songs and order them before playing the first one, as illustrated by playlist 302, or may periodically add new songs to the playlist while a previous song is already playing or as it ends.

As illustrated in FIG. 3B, playlists may include media other than songs. Playlist 352 consists of a set 354 of videos of episodes of a television show. In one configuration videos are sequentially displayed on media device 101.

While certain methods and systems of this application are described in terms of adding songs to a playlist, one skilled in the art will appreciate that these methods and systems can be applied to any type of media item selected by a user. These methods and systems are also applicable to selecting a single media item for playing on media device 101. The user may, for example, request specific media content, but leave it to media player application 114 to determine from where and in what format to retrieve a media item of the requested media content.

Also, the playlist, such as playlist 302, need not be generated originally by media player application 114. The media player application 114 may mimetically use playlists that are already pre-defined for different contexts and/or for different circumstances, and leave it to the processor 201 to select individual media items to insert into the playlist 302. These skeletal playlists may also be generated by the media player application 114 ahead of time based on a user's music library, with the processor 201 making minimal, if any, alterations to the playlist at run-time. Finally, media player application 114 may contact a remote server, such as media store 107, to generate the playlist. In this implementation, media player application 114 sends a list media items found in its library along with other relevant information, such as, for example, the media device's attributes, operating state and other context information. The remote serve may also determine the predicted change in operating state associated with a media item, or may determine the desirability of a media item. The media player application 114 then receives a playlist from the remote server in response. Alternatively, the remote server may be aware of the content of the user's music library or other relevant information, thereby limiting the amount of information that needs to be included when requesting a playlist from the remote server. Having a remote server generate the playlist allows for the implementation of more complex algorithms for generating a playlist, such as playlist 302 or 352, when processing and other resources are limited on the media device 101.

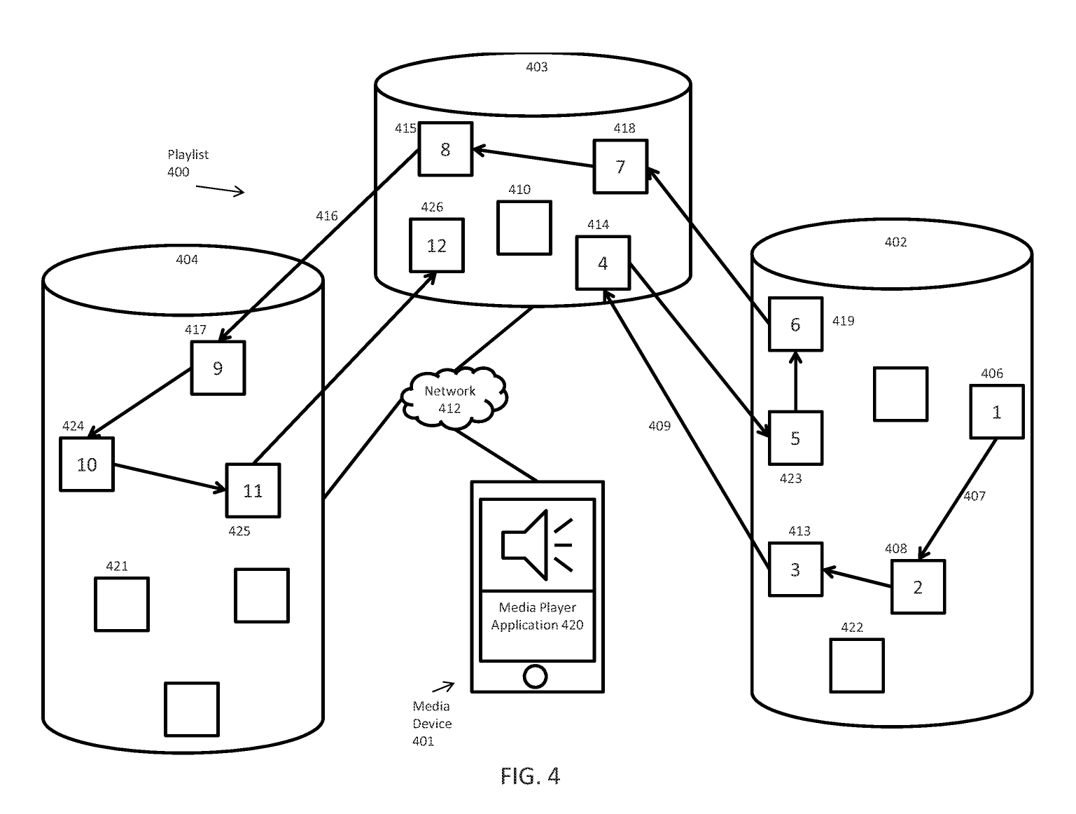

FIG. 4 is a diagram of a playlist 400 generated by a media player application 420. The playlist 400 includes songs 406, 408, 413, 414, 419, 418, 415, 417, 423, 424, 425, and 426. As discussed previous, a user's music library may span multiple devices. In FIG. 4, media device 401 may have access to songs stored on internal storage 402 and be able to stream and/or download other songs from storage device 404 and/or server 403 via network 412.

The playlist 400 may be generated in response to a user directly requesting it, if the user fails to select a second song when a first selected song ends, or can be created when the media player application 420 is first installed and configured to automatically incorporate newly added songs.

The process for generating the playlist 400 may take into account an operating state of media device 401, the effect adding a song to the playlist 400 may have on this operating state, and the desirability of the song. The playlist 400 of FIG. 4, for example, starts at song 406 and, after song 406 ends, goes through transition 407 and proceeds to song 408. When song 408 ends, song 413 begins to play next, and so on.

Media player application 420 does not need to play every song in the user's music library, such as songs 410, 421, and 422. When initially requesting the playlist 400, a user may specify attributes of songs to be included in the playlist 400. This may result in media player application 420 eliminating at an earlier stage of the selection process, not calculating desirability for, and/or not predicting a change in operating state for songs lacking this attribute. In certain configurations, the media player application 420 also preemptively eliminates songs based on attributes of media device 401, such as songs whose formats are not supported by media device 401. This optional filtering step may be integrated into the overall process for adding media items to a playlist 400 as discussed in greater detail below.

The playlist 400 of the present application need not be limited to songs found on internal storage 402 of media device 401. For example, after song 413 completes, the media player application 420 may determine that that the next song to be played is not on internal storage 402, but can instead be downloaded from remote server 403. Therefore, when song 413 ends, the playlist 400 goes through transition 409 and song 414 begins to play. Similarly, after song 419 ends, the media player application 420 may begin to play song 418 that was also downloaded from the remote server 403. The downloading of songs from the remote server 403 may occur when the playlist first begins playing. Alternatively, media player application 420 may predict how much time the downloading will require and begin the process at a later appropriate time. Another approach allows media player application 420 to wait until the last moment to begin downloading in order to avoid downloading unnecessary songs in case the user stops playing songs in the playlist, and to take advantage of fluctuations in connection quality that may result in improved download speeds at specific times. The media player application 420 may also download multiple songs simultaneously in order to limit the number of times a modem has to be turned on. For example, the media player application 420 may have downloaded songs 415 and 418 concurrently. Regardless of when the songs are downloaded, transitioning between different sources of media content may be transparent to the user.

The playlist 400 may also seamlessly mix downloaded songs and streamed content. Song 415 may be downloaded from remote server 403, while the next song, song 417, may be streamed from storage device 404 via network 412. However, the user may not be aware of transition 416, and simply hear song 415 end and song 417 begin. Pre-buffering of song 417 may be used to ensure an uninterrupted and/or seamless transition 416.

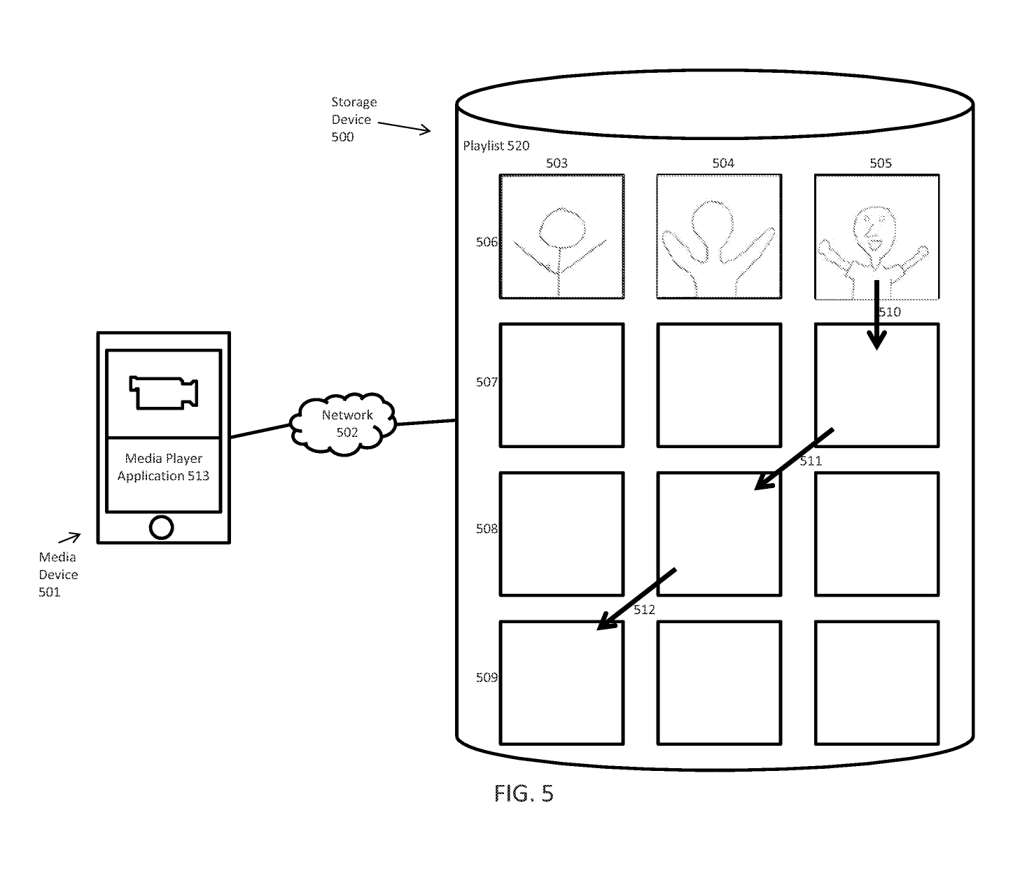

FIG. 5 is a diagram of a playlist 520 including media items in one or more video formats, such as video format 503, 504, and 505. Here, media device 501 can stream videos from storage device 500 via network 502. The videos in this example include programs 506-509, and each program comes in three formats of progressively higher quality, such as formats 503-505. The higher quality formats may be more desirable to a user, but may also have a greater negative effect on an operating state and/or performance of media device 501. For example, when playing program 506 in format 503, media device 501 may be able to run its wireless modem for connecting to network 502 at a lower clock-speed. However, a higher clock-speed may be required for streaming program 506 in format 505. Since clock speed is generally correlated with power consumption, processing video in format 505 results in a greater change in the remaining battery charge of media device 501 than processing video in format 503.

In this example, while playing program 506, media device 501 may still have plenty of battery life, and, therefore, media player application 513 may play the video with the highest quality format, i.e. format 505. Once the program 506 ends, the charge remaining on the media device battery 204 will have decreased, but media player application 513 may determine during transition 510 that the benefit of the superior format outweighs the negative impact it has on the battery 204. Therefore, media player application 513 displays program 507 in format 505. However, while transitioning to program 508, the media application 513 may determine that the battery charge is low enough that program 508 should be played in format 504, even though the higher format is still more desirable. By transition 512, media player application 513 may determine that battery charge is very low, and that it's necessary to play program 509 in format 503.

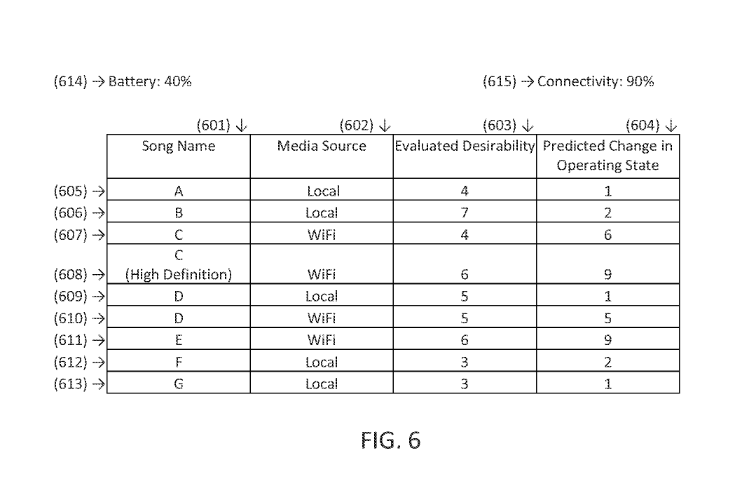

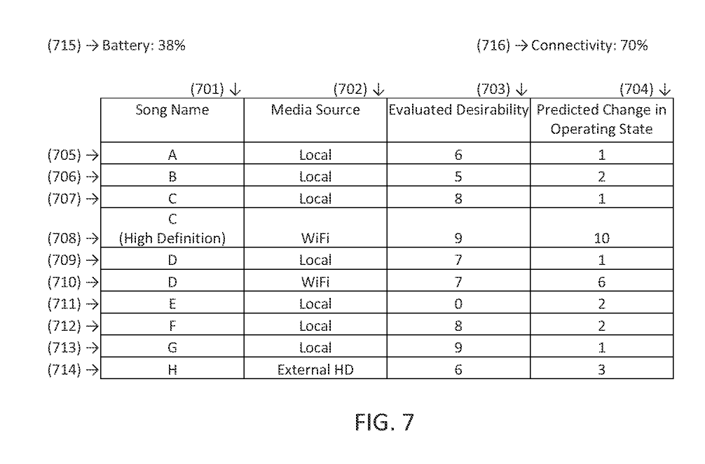

FIGS. 6 and 7 show a table of media items, specifically songs, which the media player application 513 may have access to when preparing the playlist shown in FIG. 4.

In FIG. 6, remaining battery charge 614 is a monitored operating state, and connectivity 615 is a measurement of the quality of, for example, a WiFi connection over which some of the media items in the user's media library may be obtained. Songs A-G are listed under song names 601 column in rows 605-613, along with the source 602 column from which they can be retrieved, their desirability 603 column to the user, and the effect 604 column that retrieving or playing them would have on the monitored operating state. In one implementation, numbers ranging from 1 (lowest) to 10 (highest) are assigned to both desirability 603 and effect 604. However, this is for illustrative purposes. Another implementation may assign other values to these or other factors for certain media items, or involve other methods for evaluating these factors in place of numerical values.

In one example, a goal of the media player application, such as application 420 and/or 513, is to add the most desirably media item to the playlist 400 that concurrently results in the least change in the monitored operating state. The songs to choose from include two versions of song C, where row 608 is a standard format of the song, while row 609 is in a high definition format. Also, song D can be found both on the local hard drive (row 609) and on a remote server over the WiFi connection (row 610). For simplicity, all songs in this example are either on the internal hard drive (Local) such as data storage 205 or on a remote server 403 that the media player application 420 can access over a WiFi connection.

The desirability (603 column) of a media item may be evaluated by the media player application 420 based on any number of factors. It may be based on a user preference found in a user's profile or the user's past listening and/or consumption history. Instead, or in combination with this information, desirability 603 can also be based on external information, such as a song's ratings by magazines, its commercial success, or its popularity among a group of users such as the general population. The user may also specify playlist characteristics when requesting the playlist 400 that can impact the desirability of songs. For example, the user may request songs of the Rock genre that are short. Such a request would increase the desirability 603 of songs that match these two factors.

The evaluated desirability 603 can also take into account what songs have been previously played in the playlist 400. This allows the media player application 420 to take advantage of the fact that some songs simply flow better from one to the next. Desirability 603 may also take into account the desirability 603 of future songs. For example, a song may not be particularly desirable to the user by itself, but enhance the desirability 603 of one or more future songs by creating a smooth transition or because a set of songs work well and/or are more desirable in combination.

Previous user interactions with the playlist may also impact the desirability 603 of songs. After the media player application 420 has generated a playlist 400 and the user media device 401 begins playing songs from the playlist 400, the user has a number of options that can affect the future direction of the playlist 400. The user may interact with media player application 420 to skip songs or insert new songs. The user may also interact with the media player application 420 and/or media device 401 to lower or increase the volume while a song is playing, which are actions that the media player application 420 may interpret as signs that the user likes or dislikes a song. Such user interactions can have an impact on the desirability 603 of other songs available for addition to the playlist 400. For example, if, in the middle of a techno playlist, the user selects a classic rock song for insertion into playlist 400, the media player application 420 may begin to evaluate the desirability 603 of classic rock songs more highly.

Furthermore, the media player application 420 can take into account the format of a media item when evaluating its desirability. For example, the media player application 420 may have access to two copies of song C: one in a normal format (row 607) and the other in high definition (row 608). Although these are two versions of the same song, and therefore may match the user's interests and the overall flow of the playlist 400 equally, the high definition version of song C (row 608) may have a higher desirability 603 due to the higher quality sound it produces. Desirability 603 can also take into account the context in which the user is listening to this playlist 400. For example, while normally the high definition version of song C (row 608) may have a much higher desirability than the standard version (row 607), if the playlist 400 is being played while the user is running, the difference between the standard (row 607) and high definition (row 608) formats may not be very noticeable to the user. In this situation, the difference in desirability 603 between the standard (row 607) and the high definition (row 608) versions of song C could be non-existent, which the media player application 420 would take into account when generating the playlist 400.

In certain configuration, the media player application 420 determines the predicted change in operating state 604 associated with retrieving and/or playing a song. In certain implementations, effect 604 includes a measurement of anticipated power required to download and play a song. Multiple operating states can also be simultaneously monitored. This may result in multiple predicted changes for each media item that can be simultaneously included in the selection process.

There are a number of ways that a media player application 420 can predict a change in operating state 604. In one configuration, the media player application 420 uses a look-up table. The table may be multi-dimensional and indexed by media source, media format, operating state the change is predicted for, or a combination thereof. The value retrieved from this look-up table can then be adjusted based on other factors, such as size of a media item and/or, in the case of media sources accessed via a wireless connection, connection quality. The predicted change 604 in the monitored operating state can also be derived based on previous media items in the playlist 400. For example, the media player application 420 may observe how much power was consumed by downloading a previous song from a remote server 403 and playing it. This value can then be used as a predictor for the change in operating state 604 associated with other media items from the same source. As with the look-up table, these observed changes in operating state can also be adjusted to provide a more accurate prediction.

Media player application 420 may also take into account features of the media content when predicting a change in operating state. For example, songs with a large dynamic range may cause a speaker's audio amplifiers to require more power. Media player application may utilize this information to predict a larger change in operating state for songs with a larger dynamic range. As another example, videos that have a higher average brightness may require more power to display.

Media player application 420 may also consider other factors associated with playing a media item when predicting a change in operating state. Some media items, due to their format or their content, may require more processing resources when playing then others. For example, DSP 202 may need to run at a higher clock rate when playing a high definition media item than a low definition media item. The higher clock speed may result in higher power consumption by DSP 202, which in turn would be reflected in a larger predicted change associated with playing high definition media item.

Media player application 420 may also take into account the circumstances under which a media item is played when predicting a change in operating state. The higher power consumption associated with a larger dynamic range is more prevalent with speakers than with headphones. Thus, when a user is using speakers, media player application may predict a large change in operating state for a media item with a large dynamic range than for the same media item when the user is using headphones.

In FIG. 6, there are two identical copies of song D in rows 609 and 610, but since a wireless connection is required to retrieve the version in row 610, adding song D of row 610 to the playlist 400 results in a larger change of the operating state. Song E (row 611) is retrieved from the same source as song D of row 610, but, in this example, song E (row 611) is a larger file than song D (row 610), and thus the wireless modem must remain on for longer in order to download song E. Therefore, song E (row 611) will result in a larger change of the operating state than song D of row 610. As previously mentioned, the exemplary media player also has access to two versions of song C, one in standard format (row 607) and the other in high definition (row 608). Here, the song in high definition (row 608) may have a higher desirability due to the higher quality sound of the high definition format, but it also has a larger effect on the operating state. This can be both due to the fact that song C of row 608 is a larger file than song C of row 607, and thus takes longer to download, or because playing a high definition song requires the DSP to run at a higher clock-rate and thus use more power. If the operating state monitored includes processor load, temperature, and/or memory space, then differences between media items could result in other factors impacting the predicted change 604 in the monitored operating state.

FIG. 7 includes the same table of songs available to the media player, but at a later point in time. Since then the remaining batter charge 715 and the quality of the connection 716 have gone down. Changes in the monitored operating state can affect which media items are added for the playlist 400. In one configuration, when an operating state is in a worse condition, the media player application 420 is less likely to select media items that would further negatively impact the operating state. Furthermore, if the quality of a connection has decreased, then it likely takes longer to download media items over a wireless connection. Since longer download times may result in higher power consumption, the effect on the operating state of obtaining each media item from a WiFi source is also increased.

In one example, the media player application 420 has decided to download and add song E (row 611) to the playlist 400, which has affected the desirability 603 of all other songs in the table. While, in FIG. 6, song B (row 606) may appear to be the better candidate due to its desirability 603 of 7 and predicted change 604 of 2, the media player application 420 may realize that adding song E (row 611) would greatly boost the desirability 603 of songs F (row 612) and G (row 613), whose desirability 603 went from 3 and 3 in FIGS. 6 to 8 and 9, respectively, in FIG. 7. Thus, by taking into account the potential future desirability 603 of other songs, the media player application 420 is able to select a song that will maximize the desirability 603 of the overall playlist 400. Since listening to the same song twice is probably not very enjoyable, the desirability 603 of song E (row 711) may decrease to 0.

Since song E (row 711) has been downloaded and is now locally available, adding song E (row 711) to the playlist 400 also greatly decreases the change to the operating state associated with adding song E (row 711) to the playlist 400 a second time. Furthermore, while downloading song E (row 711), the media player application 420 also downloaded the standard version of song C (row 707). This could have occurred because the media player application 420 predicted that this song would fit well into the playlist 400 in the future, and took advantage of the great connection quality at the time to download it along with song E. The media player application 420 could thus be aware that connection quality can randomly change over time, and take advantage of favorable conditions to obtain desirable songs. The same is true for situation where the predicted change 704 or the operating state is favorable. For example, when there is only a light load on the processor 201 or sufficient memory space available, the media player application 420 could actively select media items that have high demands on these resources, in order to conserve the novelty of desirable, low-impact media items for when computational or memory resources are scare. In another example, when the media device 101 is connected to an outlet and its battery is charging, the media player 101 could utilize the opportunity to download any songs it might deem desirable in the near future for later consumption. Similarly, when the user is directly connected to the user's home network, the media player may directly download songs from the user's desktop computer, instead of having to later retrieve them over a weaker wireless data connection, the Internet, and/or network 412.

Another feature to note is that the media player application 420 may continuously monitor the media device's 401 connections for new media items and new media sources. In this example, in the time between FIG. 6 and FIG. 7, the user may have connected a USB drive with new song H (row 714). The media player application 420 may become aware of its existence, and add it to the list of potential candidates for the playlist 400.

While selecting media items or generating a playlist, media player application 420 may also take into account financial considerations. Financial considerations may be an additional factor considered when generating a playlist or may be incorporated into existing factors, such as the desirability of a media item to the user. These financial considerations may include the user's budget, the cost of the media item to the user, the cost of the media item to the provider, and any profit the provider may make by having the user purchase the media item.

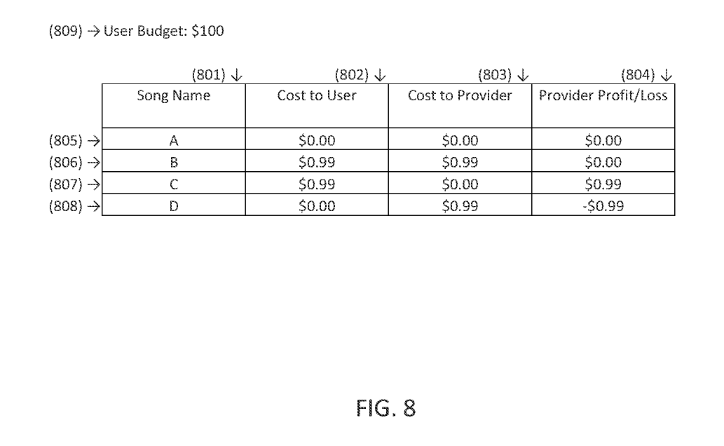

In one exemplary scenario, media player application 420 may have access to songs found in the table shown of FIG. 8. Specifically, media player application 420 may be able to select from songs A-D in rows 805-808, respectively. These may be songs not owned by the user, such as songs available for downloading or streaming from media store 107 for a fee. Their names are listed in column 801, along with the cost to the user associated with playing the song in column 802, the cost to the provider associated with giving the user access to the song in column 803, and the resultant profit/loss of the provider in column 804. A budget of a user, such as budget 809, may also be incorporated into the financial considerations.

To evaluate financial considerations, media player application 420 may consider the cost to the user associated with playing a media item. Song A (row 805) may be a free song available for downloading (e.g., available legally and without charge directly from a service associated with an artist or record label), whereas song B (row 806) would cost the user $0.99 to download. This can be taken into account when evaluating the desirability of media items. Here, song A (row 805) and song B (row 806) may have identical desirability if both were free, but since song B (row 806) costs $0.99, media player application 420 may instead evaluate song A (row 805) as more desirable to the user.

Financial considerations may also include costs to the provider, such as media store 107, associated with enabling the user to play the song. Such costs may be tied to royalties media store 107 has to pay every time a user downloads a song. For example, media store 107 may sell song B (row 806) and song C (row 807) at the same price (column 802), but selling the two songs may cost media store 107 differently (column 803). This may be the case when, for example, the rights to song C (row 807) are owned by media store 107, while the rights to song B (row 806) are owned by another entity that media store 107 has to pay royalties to. Instead of considering the cost to the user and to the provider separately, media player application 420 may also consider the profit media store 107 stands to make from selling media items, or the loss associated with such a sale (column 804). Here, media store 107 makes a profit of $0.99 every time media player application 420 downloads song C (row 807), but makes no profit when media player application 420 downloads song B (row 806).

Furthermore, financial considerations may also incorporate a budget of the user. This budget may be the amount of credit the user has with media store 107, or may be the balance of another financial account owned by the user. The user may, for example, deposit a specific amount with media store 107, either once or on a periodic basis, and allow media player application 420 to spend this money on new media items.

When selecting media items or generating playlists, media player application 420 may take into account financial considerations and any components thereof. These financial considerations may be incorporated into the desirability of a media item, may constitute a separate factor utilized in the same manner as the desirability of a media item, the current state of an operating state, or the predicted change in operating state, or may be accounted for in the initial filtering of media items.

One or more of columns 802-804 may be considered individually or in any other combination. For example, media player application 420 may consider a cost to the user and/or to the provider as a negative factor when evaluating the desirability of a media item. Media player application 420 may also, or instead, consider the profit the provider stands to make as a positive factor when evaluating the desirability of a media item. Media player application 420 may also consider the user's budget and the cost of a media item before purchasing a new media item from media store 107. Media player application 420 may also use these factors to filter the set of media items media player application 420 selects from. For example, media player application 420 may first only evaluate media items that do not cost the user anything for inclusion into the playlist, and only consider media items that are not free if it fails to select an appropriate media item from the free set. Media player application 420 may also ignore media items that would result in a loss to the provider, such as song D (row 808). Columns 802-804 may be weighted identically or differently when considered. For example, cost to the user may be an important factor when evaluating desirability of media items, whereas the profit the provider stands to make is only used as a tie breaker.

While financial considerations have so far been described in conjuncture with monitoring an operating state and predicating a change in operating state, they may also be considered separately. In fact, financial considerations can replace or supplement these factors. Instead of monitoring an operating state, media player application 420 may monitor the user's budget, such as budget 809. Instead of predicting a change in the operating state associated with a media item, media player application 420 may determine the cost to the user of playing the media item. By replacing the state of the operating state and the predicted change in operating state in this manner, media player application 420 may utilize the methods, systems and processes discussed in this application to select media items or add media items to a playlist based on financial considerations and desirability, without taking into account the current state of an operating state or a predicted change thereto. Furthermore, financial considerations may also be taken into consideration as additional factors that may impact the selection of media items. Media player application 420 may, for example, select a media item based on its desirability, the current state of an operating state, a predicated change in operating state associated with the media item, and the cost of the media item to the user.

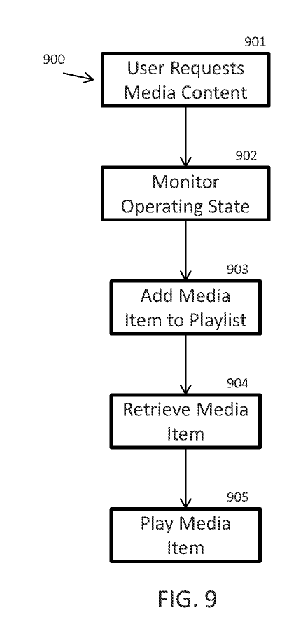

FIG. 6, FIG. 7 and FIG. 8 serve as an exemplary situation, and should not be considered as the only possible implementation of the systems and methods described in this application. The same applies to FIGS. 9-14 described below.

FIGS. 9-11 illustrate examples of processes for generating playlists.

FIG. 9 is a flowchart of a process 900 for selecting and playing a single media item. First, a user may select a single media content to be played or request a recommendation from the media player application 420 (Step 901). It is up to the media player application 420 to select an appropriate media item while balancing desirability to the user, the current operating state of the user media device, and the predicted change in operation state 604 associated with retrieving and playing the media item. Then, the media player application 420 obtains information on the current state of one or more operating states of the media device 401 (Step 902). This can be done through calls to low-level drivers, by retrieving data-structures populated by parallel processes, and/or by reading a hardware register. The media player application 420 then selects the media item (Step 903). The selected media item then is retrieved (Step 904). This may include downloading the media item from a remote server 403 or simply looking up a pointer to a locally stored copy of the media item inn, for example, data storage 205. The media item is then played (Step 906).

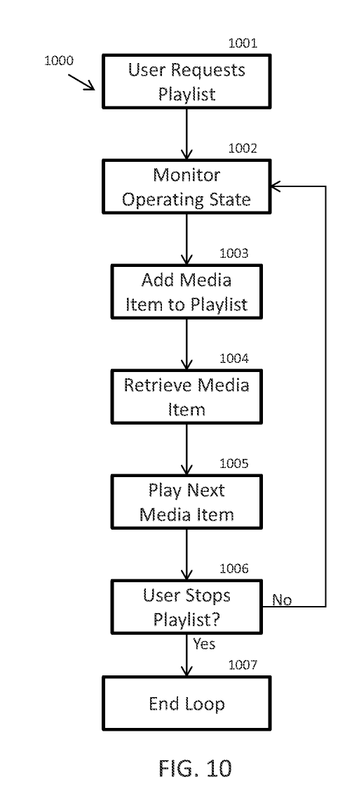

FIG. 10 is a flowchart of a process 1000 for generating a continuous playlist. As with process 900, process 1000 may begin with the user selecting media content for playing or with the user requesting a playlist from the media player application 420 (Step 1001). The media player application 420 then obtains information on the current state of one or more operating states of the media device 401 (Step 1002). The media player application 420 then selects a media item (Step 1003). The selection step can also simultaneously add multiple media items to the playlist 400. The media player application 420 then retrieves the selected media item (Step 1005). While the media item is playing, the media player application 420 checks whether the user has requested the media player to stop the playlist 400 (Step 1006). The media player application 420 can also monitor whether the user has requested the current media item to be skipped or a new media item to be inserted into the playlist 400. Skipped or inserted media items can affect the desirability 603 and/or 703 of media items in the user's media library, and therefore which media items are added to the playlist 400 in the future. If the user has halted the automatically generated playlist 400, the process stops adding further media items to the playlist (Step 1007). Otherwise, the process 1000 goes back to either step 1002, as illustrated, or to step 1003. Returning to step 1002 allows the media player application 420 to monitor the current state of the operating states every time before a new media item is selected, and the new operating state can be taken into account when selecting the next media item. Going directly from step 1006 to step 1003 may save processing that can be avoided if the operating state changes slowly or in a predictable manner. If the operating state is predictable, the process may monitor the actual operating state rarely, and interpolate using the predicted change in operating state.

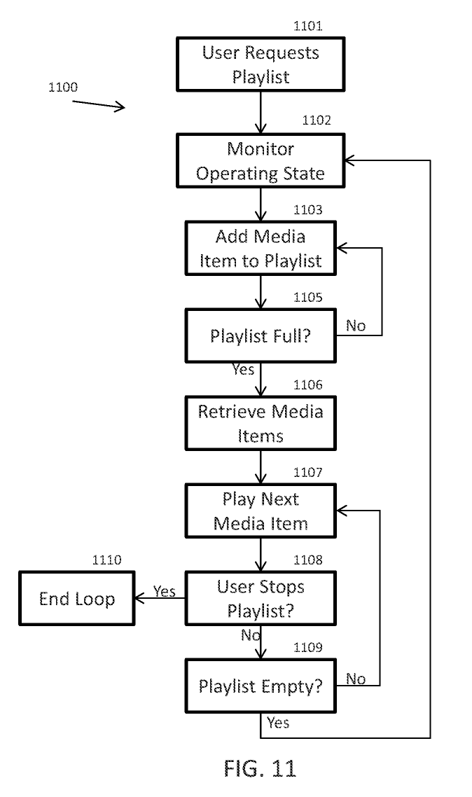

FIG. 11 is flowchart of another potential process 1100 for generating a continuous playlist. This version though anticipates multiple media items being added to the playlist at a time. Process 1100 may begin in a similar manner to process 1000, by the user selecting media content, or by the user requesting a playlist from the media player application 420 (Step 1101). The media player application 420 then obtains information on the current state of one or more operating states of the media device 401 (Step 1102). The media player application 420 then selects one or more media items and adds them to the playlist 400 (Step 1103). The media player application 420 then checks if the playlist 400 is full (Step 1105). Media player application 420 may also always pre-buffer a certain number of media items that will be played in the future. If the playlist 400 is full or enough future items have been added, the process 1100 moves on to step 1106. Otherwise, it returns to step 1103 and adds further media items to the playlist 400.

If the playlist 400 is full or enough future items have been added, the media player application 420 retrieves the media items in the playlist 400 (Step 1106). This can entail either retrieving all media items in the playlist 400 or only a subset. The media player application 420 then plays the next media item in the playlist 400 (Step 1107). While the media item is playing, the media player application 420 checks whether the user has requested the media player application 420 to stop the playlist 400. If the user has halted the playlist 400, the media player application 420 stops adding further media items to the playlist 400 (Step 1110). If the user interacts with the media player application 420 to manipulate the playlist 400, such as by removing or adding media items, the process 1100 may return to step 1102 or 1103 to generate a new playlist 400 or alter the current one. If only a subset of the media items of the playlist 400 have been retrieved, the media player application 420 may also check whether it should retrieve further media items. For example, it may check a connection quality and see if conditions are favorable for downloading further media items. Or, the media player application 420 may note it must begin downloading future media items at this time in order to avoid interruptions in the playlist due to downloading.

If neither of these situations is present, and further media items are already present in the playlist 400, the media player application 420 plays the next media item (Step 1107). Alternatively, the media player application 420 may determine that the playlist 400 is empty or that only a few media items remain. If that is the case, the process 1100 returns to either step 1102 or step 1103, and the media player application 420 adds further media items to the playlist 400.

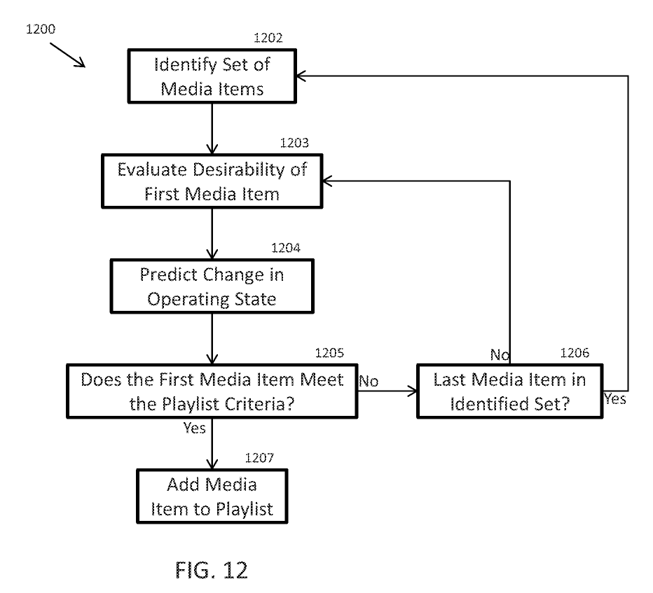

FIGS. 12-14 illustrate processes 1200, 1300 and 1400, respectively, for selecting one or more media items in any of steps 903, 1003 and 1103 of process 900, 1000 and 1100 respectively.

FIG. 12 is a flowchart of process 1200 for sequentially evaluating media items and adding a media item to a playlist. Process 1200 can be triggered by any one of process 900, 1000 or 1100 or from another context. The media player application 420 identifies a set of media items (Step 1202). These media items may each have different media content, or may contain the same media content in multiple different formats. The identified media items can also be distributed across multiple devices that the user media device 401 is connected to, and require retrieval over multiple different connections. The set of identified media items need not include all media items found on a given device, but can be a subset therefore. The media player application 420 may, for example, filter out media items that are in an unsupported format or belonging to a music genre different from the genre of the playlist. The media player application 420 then evaluates the desirability of a first media item of the identified set utilizing any of the approaches previously discussed (Step 1203). The media player application 420 then predicts a change in operating state associated with retrieving or playing the first media item utilizing any of the approaches previously discussed (Step 1204).

The media player application 420 then determines whether the first media item meets a playlist criteria. The playlist criteria may include a set of conditions that have to be met. Evaluating the playlist criteria may involve assigning scores to each of the first media item's desirability, predicted change in operating state, and the current state of the operating state. Given desirability d, predicted change in operating state p, current state of operating state o and constants k, l and m, exemplary playlist criteria may include:

(d>k)&&(l<o−p)

(d>k)&&(l>p/o)

(d−p+o>k)

(d−p/o>k)

If multiple operating states are monitored simultaneously, calculations related to the predicted change in operating state and the current state of the operating state may involve n-dimensional vectors, wherein n is the number of monitored operating states. Separate conditions may exist for each monitored operating state, or the monitored operating states can be considered simultaneously. The monitored operating states may also be weighted when evaluating the playlist criteria. Given desirability d, vector of predicted changes in operating states p, vector of current states of operating states o, constants k and l, and constant vectors m and n, exemplary playlist criteria may include:

(d>k)&&(l<min(o−p))

(d>k)&&(m>p./o)

(d*1−p+o>m)

(d−∥p./o∥>k)

In the above equations, ∥x∥ is the Euclidean norm of vector x, p./o results in a vector for which entry k is pₖ/oₖ, and d*1 results in a vector for which every entry is d.

If the media player application 420 determines that the first media item meets the playlist criteria, the media player application 420 adds the first media item to the playlist 400 (Step 1207).

However, if the media player application 420 determines that the first media item does not meet the playlist criteria, the media player application 420 determines if all media items in the identified set of media items have been compared against the playlist criteria (Step 1205). If there are still media items remaining in the identified set, the media player application 420 evaluates the desirability predicted change in operating state of the next media item in the set (Step 1203-1204). If, however, the media player application 420 determines that no more media items remain in the identified set, the media player application 420 may attempt to identify a new set of media items (Step 1202). This may involve identifying media items from media sources not previously considered or relaxing the filtering constraints discussed above. For example, the media player application 420 may initially attempt to generate a playlist using only locally available media items, but expand the search to media items found on the Internet or a remote server if no local media item meets the playlist criteria. The media player application 420 may also lower the threshold of the playlist criteria. In addition, or alternatively, the media player application 420 may inform the user that it has failed to locate an appropriate media item and/or provide the user with an opportunity to input an adjustment to the playlist criteria or the filters in step 1202.

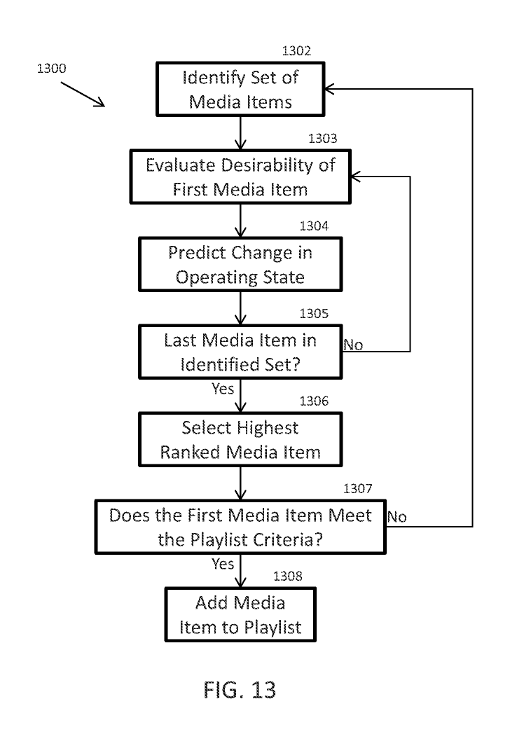

FIG. 13 is a flowchart of process 1300 for comparing media items to each other and adding the best media item from a set to the playlist 400. The media player application 420 identifies and optionally filters a set of media items (Step 1302). The media player application 420 then evaluates the desirability of a first media item (Step 1303). The media player application 420 then predicts the change in operating state associated with retrieving or playing the first media item (Step 1304). The media player application 420 then determines if this is the last media item of the set (Step 1305). If there are further media items remaining in the set, the media player application 420 evaluates the desirability and predicted change in operating state of the next media (Steps 1304-1305). Alternatively, the media player application 420 may first evaluate the desirability of all media items in the set before predicting the change in operating state associated with each media item in the set.

If the media player application 420 determines that this has been the last media item in the identified set, and that thus the desirability and predicted change in operating state of each media item in the set is known, the media player application 420 compares the media items of the set with each other in order select a media item (Step 1306). This may involve ranking the media items based on their desirability, predicted change in operating state, and/or the current state of the operating state. The ranking may also be accomplished by calculating an overall score for each media item based on one of the algorithms discussed above in connection with FIG. 11. This may involve treating any one of the above playlist criteria as equations and calculating the constants and constant vectors for each media item. If the playlist criteria involve a single constant, this constant may be used as the overall score. If the playlist criteria involve multiple constants and/or a vector of constants, the sum, norm, minimum or maximum of the multiple constants and/or vector of constants may be used as the overall score. Instead of then comparing each media item with the playlist criteria, the media player application 420 may select the highest ranked media item or the media item with the greatest overall score. The media player application may also compare the selected media item with the playlist criteria (Step 1307). If the selected media item meets the playlist criteria, the media player application may add the selected media item to the playlist 400 (Step 1308). However, if the selected media item does not meet the playlist criteria, the media player application may identify a new set of media items and/or relax the playlist criteria or filtering constraints, similar to process 1200.

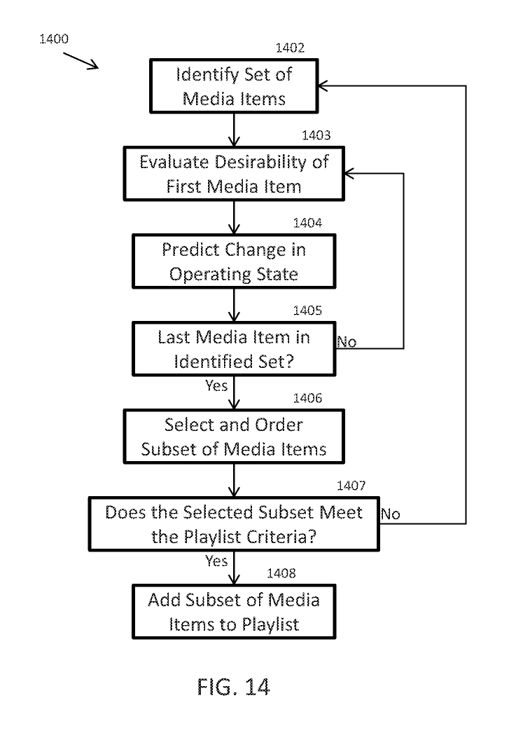

FIG. 14 is a flowchart of process 1400 for selecting and adding an ordered set of media items to the playlist. As in process 1300, the media player application 420 identifies a set of media items and evaluates the desirability and predicted effect on the operating state of each media item (Steps 1402-1405).

The media player application 420 then selects and orders multiple media items from the set (Step 1406). The media player application 420 may perform the selection utilizing one of the approaches discussed in FIGS. 12-13. For example, the media player application 420 may select the first n media items that satisfy the playlist criteria. In this case, the media player application may only evaluate the desirability and predict change in operating state for media items until it has found the first n media items that satisfy the playlist criteria. Alternatively, media player application 420 may rank all media items in the identified set and then select the top n items for inclusion in the playlist. The media player application 420 may then randomly select the order in which the media items will be played in the playlist 400. The media player application 420 may also order the selected media items on the fly in order to take advantage of fluctuations in the current state of an operating state or the predicted change in operating state associated with a media item.

More complex algorithms for ordering the media items for the playlist are also possible. The ordering of media items may be performed in order to maximize a function. The maximization may also contain a number of constraints. For example, the process may maximize the desirability of the overall playlist, subject to constraints on the operating states or the predicted changes thereto. The process may also attempt to maximize the minimum desirability of individual media items in the playlist subject constraints on the operating states or the predicted changes thereto. Alternatively, the constraint may be related to a minimum desirability of individual media items and/or the overall playlist, while the process attempts to minimize impact on the operating states of the user media device. A set of calculated future operating states after all media items on the playlist have been played may also be maximized or used as a constraint. As one skilled in the art will note, the media player application can utilize any set of rules or any one of a large number of possible algorithms known from numerical optimization, convex optimization, or linear algebra.

Furthermore, the media player application 420 may utilize any such algorithms not just to order the selected media items, but as part of the selection process as well.

As in process 1300, the media player application 420 may determine whether the selected and ordered media items meet the playlist criteria. If they don't the media player application 420 may repeat process 1400 starting at step 1402 with a new or expanded set of media items. If the selected and ordered media items do meet the playlist criteria, the media player application 420 adds the selected media items in the determined order to playlist 400.

The steps discussed in processes 900, 1000, 1100, 1200, 1300 and 1400 can be rearranged in any order. Furthermore, individual steps may be eliminated or combined. For example, an exemplary process may only utilize the evaluated desirability of media items and the predicted change in operating state to select media items, allowing it to skip steps for monitoring the operating state. In another example, media player application 420 may solely utilize the desirability of media items to recommend media items. Media player application 420 may also recommend media items according to financial considerations, or due to a combination of financial considerations and the desirability of media items. The processes can also be substituted or combined in any manner.

It will be apparent to those of ordinary skill in the art that the systems and methods involved in the present application may be embodied in a computer program product that includes a computer usable, non-transitory, and/or readable medium. For example, such a computer usable medium may consist of a read only memory device, such as a CD ROM disk or conventional ROM devices, or a random access memory, such as a hard drive device or a computer diskette, or flash memory device having a computer readable program code stored thereon.

It is understood that the various features, elements, or processes of the foregoing figures and description are interchangeable or combinable to realize or practice the implementations describe herein. Those skilled in the art will appreciate that aspects of the application can be practiced by other than the described implementations, which are presented for purposes of illustration rather than of limitation, and the aspects are limited only by the claims which follow.

What is claimed is:

1. A method for selecting media content for a playlist comprising:
monitoring an operating state of a user media device;
identifying a plurality of media items of the media content available for playing on the user media device;
predicting a change in the operating state associated with at least one of acquiring and playing a first media item of the plurality of media items;
evaluating a desirability of the first media item to the user;
if the first media item meets a playlist criteria, based at least in part on the evaluated desirability to the user, the operating state of the user media device, and the predicted change in the operating state of the user media device, adding the first media item to the playlist; and
if the first media item does not meet the playlist criteria, based at least in part on the evaluated desirability to the user, the operating state of the user media device, and the predicted change in the operating state of the user media device, not adding the first media item to the playlist.

2. The method of claim 1, wherein the operating state of the user media device comprises a battery charge of a battery of the user media device.

3. The method of claim 1, wherein the operating state of the user media device comprises a temperature of a component of the user media device.

4. The method of claim 1, wherein the operating state of the user media device comprises an amount of memory space available to the user media device.

5. The method of claim 1, wherein the operating state of the user media device comprises a processor load of the user media device.

6. The method of claim 1, wherein the plurality of media items comprises a plurality of versions of the same media content, wherein the plurality of versions has different formats.

7. The method of claim 1, wherein the predicted change in the operating state is based at least in part on a potential change in the operating state associated with a next media item available to be added to the playlist in the future.

8. The method of claim 1, wherein:
the plurality of media items comprises media items from a plurality of sources; and
the predicted change in the operating state is based at least in part on the source of the first media item.

9. The method of claim 8, wherein:
the plurality of sources comprises at least one of a local media storage component and at least one of a remote server; and
the predicted change in the operating state is further based at least in part on a quality of connection between the user media device and the remote server.

10. The method of claim 8, wherein the predicted change in the operating state is further based at least in part on the size of the first media item.

11. The method of claim 1, further comprising:
measuring an actual change in the operating state associated with a previous media item; and
wherein the predicted change in the operating state is based at least in part on the actual change in the operating state associated with the previous media item.

12. The method of claim 1, wherein the evaluated desirability to the user is based at least in part on a previous media item previously added to the playlist.

13. The method of claim 12, wherein the evaluated desirability to the user is further based at least in part on a potential desirability of a next media item available to be added to the playlist in the future.

14. The method of claim 1, comprising repeating one or more steps until at least one of a first condition and a second condition have been met, wherein:
the first condition comprises the one or more steps having been performed for each of the plurality of the identified plurality of media items; and
the second condition comprises adding at least one media item to the playlist;

15. The method of claim 14, wherein repeating the one or more steps includes:
assigning a score to each of the evaluated desirability to the user, the operating state of the user media device, and the predicted change in the operating state of the user media device;
calculating an overall score for each media item of the plurality of media items based at least in part on the evaluated desirability to the user, the operating state of the user media device, and the predicted change in the operating state of the user media device; and
wherein the playlist criteria is the first media item having the highest overall score.

16. The method of claim 14, wherein repeating the one or more steps includes:
assigning a score to each of the evaluated desirability to the user, the operating state of the user media device, and the predicted change in the operating state of the user media device;
selecting a subset of media items from the plurality of media items, wherein the subset is selected to maximize an overall score, and wherein the overall score is based at least in part on the evaluated desirability to the user, the operating state of the user media device, and the predicted change in the operating state of the user media device of each media item of the subset of media items; and
wherein the playlist criteria is the first media item belonging to the subset of media items.

17. A system for selecting media content for a playlist comprising:
a computer;
a computer readable medium, operatively coupled to the computer, the computer readable medium storing program codes causing the computer to perform functions comprising:
monitoring an operating state of a user media device;
identifying a plurality of media items of the media content available for playing on the user media device;
predicting a change in the operating state associated with at least one of acquiring and playing a first media item of the plurality of media items;
evaluating a desirability of the first media item to the user;
if the first media item meets a playlist criteria, based at least in part on the evaluated desirability to the user, the operating state of the user media device, and the predicted change in the operating state of the user media device, adding the first media item to the playlist; and
if the first media item does not meet the playlist criteria, based at least in part on the evaluated desirability to the user, the operating state of the user media device, and the predicted change in the operating state of the user media device, not adding the first media item to the playlist.

18. The system of claim 17, wherein the operating state of the user media device comprises a battery charge of a battery of the user media device.

19. The system of claim 17, wherein the plurality of media items comprises a plurality of versions of the same media content, wherein the plurality of versions has different formats.

20. The system of claim 17, wherein:
the plurality of media items comprises media items from a plurality of sources; and
the predicted change in the operating state is based at least in part on the source of the first media item.

21. The system of claim 20, wherein:
the plurality of sources comprises at least one of a local media storage component and at least one of a remote server; and
the predicted change in the operating state is further based at least in part on a quality of connection between the user media device and the remote server.

22. The system of claim 17, wherein the computer is further configured to:
measure an actual change in the operating state associated with a previous media item; and
wherein the predicted change in the operating state is based at least in part on the actual change in the operating state associated with the previous media item.

23. The system of claim 17, wherein the computer is configured to repeat one or more steps until at least one of a first condition and a second condition have been met, wherein:
the first condition comprises the one or more steps having been performed for each of the plurality of the identified plurality of media items; and
the second condition comprises adding at least one media item to the playlist;

24. The system of claim 23, wherein repeating the one or more steps includes:
assigning a score to each of the evaluated desirability to the user, the operating state of the user media device, and the predicted change in the operating state of the user media device;
calculating an overall score for each media item of the plurality of media items based at least in part on the evaluated desirability to the user, the operating state of the user media device, and the predicted change in the operating state of the user media device; and
wherein the playlist criteria is the first media item having the highest overall score.

25. The system of claim 23, wherein repeating the one or more steps includes:
assigning a score to each of the evaluated desirability to the user, the operating state of the user media device, and the predicted change in the operating state of the user media device;
selecting a subset of media items from the plurality of media items, wherein the subset is selected to maximize an overall score, and wherein the overall score is based at least in part on the evaluated desirability to the user, the operating state of the user media device, and the predicted change in the operating state of the user media device of each media item of the subset of media items; and
wherein the playlist criteria is the first media item belonging to the subset of media items.

26. A media device comprising:
a monitor unit arranged to monitor an operating state of the media device;
a media player unit arranged to:
identify a plurality of media items of the media content available for playing on the user media device;
predict a change in the operating state associated with at least one of acquiring and playing a first media item of the plurality of media items;
evaluate a desirability of the first media item to the user;
if the first media item meets a playlist criteria, based at least in part on the evaluated desirability to the user, the operating state of the user media device, and the predicted change in the operating state of the user media device, add the first media item to the playlist; and
if the first media item does not meet the playlist criteria, based at least in part on the evaluated desirability to the user, the operating state of the user media device, and the predicted change in the operating state of the user media device, not add the first media item to the playlist.

27. A method for selecting media content for a playlist comprising:
monitoring a budget of a user of a user media device;
identifying a plurality of media items of the media content available from a media store for playing on the user media device for a fee;
determining a cost to the user associated with at least one of acquiring and playing a first media item of the plurality of media items;
evaluating a desirability of the first media item to the user;
if the first media item meets a playlist criteria, based at least in part on the monitored budget of the user, the determined cost to the user, and the evaluated desirability to the user, adding the first media item to the playlist; and
if the first media item does not meet the playlist criteria, based at least in part on the monitored budget of the user, the determined cost to the user, and the evaluated desirability to the user, not adding the first media item to the playlist.

28. The method of claim 27, further comprising setting a limit on how many media items from a media store may be added to the playlist in a time period.

29. The method of claim 28, wherein:
the limit is associated with a monetary quantity that is pre-paid to the media store for the time period; and
wherein the user's budget is a remaining amount of the pre-paid monetary quantity.

30. The method of claim 29, further comprising:
determining a cost to the music store associated with providing the first media item to the user media device for playing;
determining whether the first media item meets the playlist criteria based at least in part on the monitored budget of the user, the determined cost to the user, the determined cost to the media store, and the evaluated desirability to the user.
